(19) United States
(12) Patent Application Publication
(10) Pub. No.: US 2009/0014558 A1
(43) Pub. Date: Jan. 15, 2009

(54) Portable sprayer/mister/fogging system for dispersing media in a uniform and controlled manner

(75) Inventors: David L. Phillips, Santa Ana, CA (US); Daniel D. Guldalj, Orange, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: ITT MANUFACTURING ENTERPRISES, INC.

(21) Appl. No.: 11/879,024

(22) Filed: Jul. 12, 2007

(51) Int. Cl. B05B 7/32

(52) U.S. Cl. 239/337

(57) ABSTRACT

The present invention provides a portable sprayer, mister or fogger system for dispensing media in a uniform and controlled manner, featuring a tubular member having two semi-tubular molded parts with an open front end, and having a living hinge for flexibly coupling together the two semi-tubular molded parts for opening for ease of assembling components of the portable sprayer, mister or fogger system therein, and for securely closing once assembled; a fluid line assembled and arranged on the inside thereof for providing the media in the form of chemical, water of other suitable fluid; a nozzle assembled and arranged in a open front end and coupled to the fluid line for providing the media; a blower for blowing the media being provided from the nozzle; a pump and power line for coupling to a pump and power source for providing a supply of electrical power; a device for simultaneously controlling the operation of the fluid provided to the nozzle and the power provided to the blower; and an on/off switch coupled via a line to the device for simultaneously turning on/off the operation of the fluid provided to the nozzle and the power to the blower in response to the user pressing the on/off switch.

### BACKGROUND OF THE INVENTION

1. Field of the Invention

The present invention relates to a sprayer, mister or fogger; and more particularly to a portable sprayer, mister or fogger for dispersing media in a uniform and controller manner.

2. Brief Description of Related Art

Sprayers, misters or foggers known in the art are designed and marketed for larger spraying areas and cost range. The units available are not portable in the sense that one can carry them; instead, they are towed or left in place.

Size, cost of equipment and media, wasted media due to size and dispersion methods result in shortcominings in the known sprayers, misters or foggers. For example, due to the cost of the equipment, small to medium user do not have access to this technology. Other shortcomings from low technology development makes equipment dangerous, unwieldy, and inefficient, e.g., fan blades are exposed; controls that operate blower do not operate the pump, or vice versa; large amounts of media are wasted due to poor dispersion techniques.

By way of example, FIG. 1 shows one such known spot sprayer that has a blower mounted in relation to front and back tubular piping coupled thereto, an external supply pipe running on the outside of the front tubular piping which is susceptible to outside influence such as catching on things or getting broken. Among other things, the known spot sprayer in FIG. 1 does not have a living hinge for ease of assembly or a combined on/off switch for simultaneously turning on/off both the blower and fluid.

U.S. Pat. No. 3,185,396, discloses a building surface applicator having concentric tubes for providing a combination of pressurized air and tar, and also having conventional hoses leading to sources of asphalt and air pressure under the control of a valve actuating trigger, which is itself connected to a motor for a glass fiber cutter mechanism and allows the synchronization of the cutting of a glass-fiber roving and the consequential flow of glass fibers with the flow of asphalt and air through tubes.

Other known patents disclose shields disposed rearwardly of nozzles. For example, U.S. Pat. No. 1,763,687 discloses a retort for a burner having a vertical panel; U.S. Pat. No. 2,705,663 discloses a spray gun having a hand shield; U.S. Pat. No. 2,737,415 discloses a paint spray gun having a shield; U.S. Pat. No. 2,746,883 discloses a process for flame spraying a plastisol having a flame spray head; and U.S. Pat. No. 4,579,280 discloses a process for heating the surface of a substrate. Among other things, all of these prior art devices operate via compressed air, and none have living hinges.

Other known patents disclose dispensers disposed in elongated supports with shield blowers associated therewith. For example, U.S. Pat. No. 4,089,441 discloses a portable manually operated duster for blowing air in order to dust; and U.S. Pat. No. 5,190,217 discloses an applicator gun for applying surface coatings with a mixture of viscous liquid and glass particles, having a cutter assembly for providing the glass particles, an exterior fitting and an interior spray nozzle for providing the liquid, and having a fan for forcing air down the barrel. Among other things, none of these prior art devices has a living hinge for ease of assembly or has a combined on/off switch for turning on/off the blower and media delivery mechanism.

### SUMMARY OF THE INVENTION

In its broadest sense, the present invention provides a new and unique portable sprayer, mister or fogger system featuring a tubular member having two semi-tubular molded parts that house various components for dispensing media and that allow for ease of assembly of the various components therein during manufacture, the two semi-tubular molded parts being securely coupled together once the portable sprayer, mister or fogger system is assembled.

The two-semi-tubular molded parts may be coupled securely together by some combination of a living hinge, an ultrasonic welding, a friction fit tab/detent, a snap, a circumferential harness. The living hinge bends to allow movement, including for flexibly opening to allow ease of assembly of various components within the tubular member and manufacture of the portable sprayer, mister or fogger system.

In one particular embodiment, the portable sprayer, mister or fogger system has a tubular member for dispensing media in a uniform and controlled manner, having such a living hinge arranged along its longitudinal axis with a section of the material that bends to allow movement, including for flexibly opening to allow ease of assembly of various components within the tubular member and manufacture of the portable sprayer, mister or fogger system, and for closing securely once assembled.

The tubular member may be made of a material capable of forming such a hinge or flexure bearing with no moving parts, including polypropylene or some other suitable lightweight plastic material.

The various components for assembly comprise one or more of the following: a fluid line securely arranged inside the tubular member for providing the media; or a nozzle arranged in an open front end of the tubular member and coupled to the fluid line for providing the media; or a pump and power line for coupling to a pump and power source for providing a supply of the media; or a blower fixedly arranged inside the tubular member and coupled to the pump and power line for blowing the chemical, water or other suitable fluid out the open front end; or an on/off switch coupled to the power and power line for simultaneously turning on/off both the provisioning of the media from the nozzle and the blower; or some combination thereof.

Such a living hinge is known in the art and includes a hinge or flexure bearing with no moving parts. For example, it generally may consists of a thin section of the material that bends to allow movement. The lack of any friction and very little wear in such a hinge makes it essential in the design of microelectromechanical systems, and the ease of manufacturing and assembly from the reduced part count makes them quite common in disposable packaging. Large-scale living hinges are most often made from polypropylene due to its excellent fatigue resistance. See, for example, the Wikipedia online encyclopedia.

In addition, the portable sprayer, mister or fogger system may include an open back end having a blower guard arranged therein for protecting a user from getting their fingers or clothes caught in blades of the blower. The tubular member may be made of a lightweight plastic so as to provide a portable, economic and easy to use system, and may have one or more inner circumferential members for frictionally engaging and securing the blower therein.

In a preferred embodiment, the present invention provides a new and unique portable sprayer, mister or fogger system for dispensing media in a uniform and controlled manner, featuring a tubular member having an open front end, and having a living hinge for opening for ease of assembling components of the portable sprayer, mister or fogger system therein, and for securely closing once assembled. The tubular member has a fluid line assembled and arranged on the inside thereof for providing the media in the form of a chemical, water of other suitable fluid; a nozzle assembled and arranged in an open front end and coupled to the fluid line for providing the media; a blower for blowing the media being provided from the nozzle; a pump and power line for coupling to a pump and power source for providing a supply of electrical power to a device for simultaneously controlling the operation of the fluid provided to the nozzle and blower; an on/off switch coupled via a line to the device for simultaneously turning on/off the operation of the fluid provided to the nozzle and blower in response to the user pressing the on/off switch; and a handle for holding the portable sprayer, mister or fogger system. As shown, the on/off switch and line are arranged in or on the handle, although embodiments are envisioned in which the on/off switch and line are arranged elsewhere, including somewhere on the tubular member.

In effect, by approaching the issue at the level of the small to medium user, the present invention is designed to provide a portable unit, that is easy to use, safer and media efficient for the small/medium or even hobby user, allowing one to carry a small tank and disperse media across a wide area with accuracy and even dispersal which saves media and time.

In operation, the present invention allows for the user to carry the unit by hand with a small water supply and disperse media over a large area with dispersal rates that are efficient and economical. The nozzle can be changed to fit any type of spray/mist/fog the user prefers or requires. The blade guard protects users from getting their fingers or clothes caught in the blower blades. The finger on/off control allows user to control pump and blower with one button, preventing the pump from continuing to spray until you shut it off separately. The present invention is light, easy to use and carry, is economical and can be priced at a range that the small to medium farms can afford to purchase and use. This will allow users who previously could not afford the more costly unit or did not want to continue to waste media to afford to spray their crops, flowers etc with ease.

The scope of the invention is intended to include all areas where spray equipment can or will be used to disperse media over an area.

### BRIEF DESCRIPTION OF THE DRAWING

FIG. 1 is a diagram of a sprayer, mister or fogger that is known in the art.

FIG. 2 is a diagram of a sprayer, mister or fogger according to the present invention.

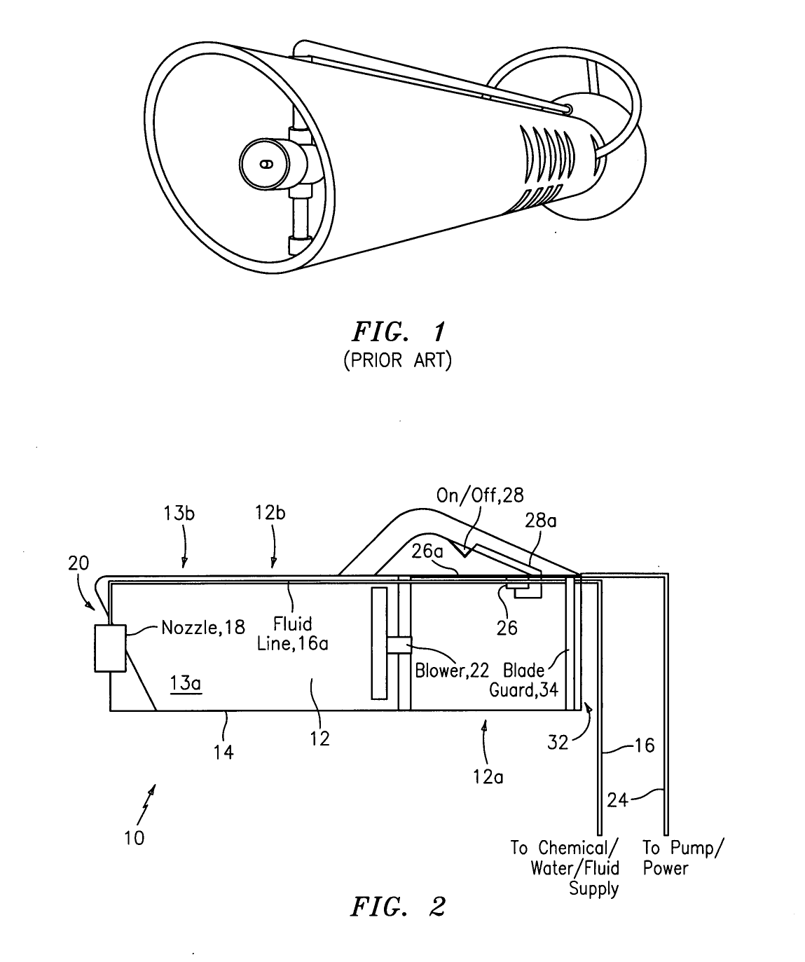

### DETAILED DESCRIPTION OF THE INVENTION

FIG. 2 shows a portable sprayer, mister or fogger system generally indicated as 10 for dispensing media in a uniform and controlled manner according to the present invention. The portable sprayer, mister or fogger system 10 features a tubular member 12 for dispensing the media, having two semi-tubular molded parts 13a, 13b (on the opposing side) with a living hinge generally indicated as 14 flexibly coupling the parts 13a, 13b together and being arranged on the tubular outer surface along its longitudinal axis as a longitudinal section of the material that bends to allow movement, including for flexibly opening to allow ease of assembly of various components within the tubular member 12 and manufacture of the portable sprayer, mister or fogger system 10, and for closing securely once assembled. As shown, the living hinge 14 is arranged along the lower surface generally indicated 12a of the tubular member 12 and couples two parts of the tubular member 12 together, which mate along the upper surface 12b. There are many different known techniques for mating together two such parts, including but not limited to one or more friction fit tabs/detents, snaps, circumferential harnesses arranged in circumferential channels, etc. The scope of the invention is not intended to be limited to any particular type, kind or manner of mating together the parts of the tubular member along the upper surface 12b. Moreover, the scope of the invention is also intended to include the tubular member taking the form of two semi-tubular molded parts that are separate pieces coupled or secured together by some combination of a living hinge, an ultrasonic welding, a friction fit tab/detent, a snap, a circumferential harness, etc.

The tubular member 12 has a fluid line 16, 16a assembled and arranged on the inside thereof for providing the media in the form of chemical, water of other suitable fluid; a nozzle 18 assembled and arranged in a open front end generally indicated as 20 thereof and coupled to the fluid line 16a for providing the media; a blower 22 for blowing the media provided from the nozzle 18; a pump and power line 24 for coupling to a pump and power source (not shown) for providing a supply of electrical power; a device 26 for simultaneously controlling the operation of the fluid provided via fluid line 16a to the nozzle 18 and the power provided via electrical line 16a provided to the blower 22; an on/off switch 28 couple via an electrical line 28a to the device 26 for simultaneously turning on/off the operation of the operation of the fluid provided to the nozzle 18 and power provided to the blower 22 in response to the user pressing the on/off switch 23; and a handle 30 for holding the portable sprayer, mister or fogger system 10. As shown, the on/off switch and line 28a are arranged in or on the handle 30, although embodiments are envisioned in which the on/off switch and line 28a are arranged elsewhere, including somewhere on the tubular member 12.

In addition, the portable sprayer, mister or fogger system 10 may include an open back end generally indicated as 32 and a blower guard 34 arranged therein for protecting the user from getting their fingers or clothes caught in blades of the blower. The tubular member 12 may be made of a lightweight plastic so as to provide a portable, economic and easy to use system, and may have one or more inner circumferential members for frictionally engaging and securing the blower therein.

There are many different known techniques for couple each of the fluid line 16, 16a, the nozzle 18, the blower 22, the device 26, the blade guard 34 to the inside of the tubular member 12, and the scope of the invention is not intended to be limited to any particular type, kind or manner of coupling the same. By way of example, the fluid line 16, 16a, may be coupled to the tubular member 12 by a suitable snap fitting mechanism or other suitable mechanism, the nozzle 18 may be coupled to the tubular member 12 by a suitable snap fitting mechanism or other suitable mechanism, the blower 22 may be coupled to the tubular member 12 by one or more inner circumferential retaining members that frictionally engage and secure the blower 22 therein; the device 26 may be couples to the tubular member 12 by a suitable snap fitting mechanism or other suitable mechanism and the blade guard 34 may be coupled to the tubular member 12 by one or more inner circumferential retaining members that frictionally engage and secure the blade guard 34 therein. The scope of the invention is intended to include types, kinds or manners of coupling two things together either now known or later developed in the future.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. A portable sprayer, mister or fogger system comprising:
a tubular member having two semi-tubular molded parts that house various components for dispensing media and that allow for ease of assembly of the various components therein during manufacture, the two semi-tubular molded parts being securely coupled together once the portable sprayer, mister or fogger system is assembled.

2. A portable sprayer, mister or fogger system according to claim 1, wherein the two-semi-tubular molded parts are coupled securely together by some combination of a living hinge, an ultrasonic welding, a friction fit tab/detent, a snap, a circumferential harness.

3. A portable sprayer, mister or fogger system according to claim 2, wherein the living hinge bends to allow movement, including for flexibly opening to allow ease of assembly of various components within the tubular member and manufacture of the portable sprayer, mister or fogger system.

4. A portable sprayer, mister or fogger system according to claim 2, the outer surface of the tubular member has one or more circumferential channels for receiving one or more circumferential harnesses.

5. A portable sprayer, mister or fogger system according to claim 1, wherein the various components assembled and arranged on the inside of the tubular member include some combination of one or more of the following:
a fluid line for providing the media in the form of chemical, water of other suitable fluid;
a nozzle arranged in an open front end of the tubular member and coupled to the fluid line for providing the media;
a blower for blowing the media being provided from the nozzle;
a pump and power line for coupling to a pump and power source for providing a supply of electrical power;
a device for simultaneously controlling the operation of the fluid provided to the nozzle and the power provided to the blower; or
an on/off switch coupled via a line to the device for simultaneously turning on/off the operation of the fluid provided to the nozzle and the power provided to the blower in response to the user pressing the on/off switch.

6. A portable sprayer, mister or fogger system according to claim 1, wherein the portable sprayer, mister or fogger system has an open back end having a blower guard arranged therein for protecting a user from getting their fingers or clothes caught in blades of the blower.

7. A portable sprayer, mister or fogger system according to claim 1, wherein the tubular member is made of a lightweight plastic so as to provide a portable, economic and easy-to-use system.

8. A portable sprayer, mister or fogger system according to claim 1, wherein the tubular member has one or more inner circumferential retaining members for frictionally engaging and securing one or more of the various components therein, including the blower. when the two semi-tubular molded parts are securely coupled together.

9. A portable sprayer, mister or fogger system according to claim 1, wherein the tubular member is made of a material such as polypropylene or some other suitable lightweight plastic material.

10. A portable sprayer, mister or fogger system comprising:
a tubular member for dispensing media in a uniform and controlled manner, having two semi-tubular molded parts with a living hinge arranged along its longitudinal axis as a longitudinal section of the material that bends to allow movement, including for flexibly opening to allow ease of assembly of various components within the tubular member during manufacture of the portable sprayer, mister or fogger system, the two-semi-tubular molded parts being held securely together once the portable sprayer, mister or fogger system is assembled.

11. A portable sprayer, mister or fogger system according to claim 10, wherein the tubular member is made of a material capable of forming a hinge or flexure bearing with no moving parts, including polypropylene or some other suitable lightweight plastic material.

12. A portable sprayer, mister or fogger system according to claim 10, wherein the various components assembled and arranged on the inside of the tubular member include some combination of one or more of the following:
a fluid line for providing the media in the form of chemical, water of other suitable fluid;
a nozzle arranged in an open front end of the tubular member and coupled to the fluid line for providing the media;
a blower for blowing the media being provided from the nozzle;
a pump and power line for coupling to a pump and power source for providing a supply of electrical power;
a device for simultaneously controlling the operation of the fluid provided to the nozzle and the power provided to the blower; or
an on/off switch coupled via a line to the device for simultaneously turning on/off the operation of the fluid provided to the nozzle and the power provided to the blower in response to the user pressing the on/off switch.

13. A portable sprayer, mister or fogger system according to claim 10, wherein the portable sprayer, mister or fogger system has an open back end having a blower guard arranged therein for protecting a user from getting their fingers or clothes caught in blades of the blower.

14. A portable sprayer, mister or fogger system according to claim 10, wherein the tubular member is made of a lightweight plastic so as to provide a portable, economic and easy-to-use system.

15. A portable sprayer, mister or fogger system according to claim 10, wherein the tubular member has one or more inner circumferential retaining members for frictionally engaging and securing one or more of the various components, including the blower, therein when the living hinge is closed.

16. A portable sprayer, mister or fogger system according to claim 10, wherein the two semi-tubular molded parts are held together along the outer tubular surface by an ultrasonic weld, friction fit tabs/detents, snaps, circumferential harnesses arranged in circumferential channels, or some combination thereof.

17. A portable sprayer, mister or fogger system for dispensing media in a uniform and controlled manner, comprising:
a tubular member having an open front end, and having a living hinge for opening for ease of assembling components of the portable sprayer, mister or fogger system therein, and for securely closing once assembled;
a fluid line assembled and arranged on the inside of the tubular member for providing the media in the form of chemical, water of other suitable fluid;
a nozzle assembled and arranged in an open front end of the tubular member and coupled to the fluid line for providing the media;
a blower assembled and arranged on the inside of the tubular member for blowing the media being provided from the nozzle;
a pump and power line for coupling to a pump and power source for providing a supply of electrical power;
a device for simultaneously controlling the operation of the fluid provided to the nozzle and the power provided to the blower; and
an on/off switch coupled via a line to the device for simultaneously turning on/off the operation of the fluid provided to the nozzle and the power provided to the blower in response to the user pressing the on/off switch.

18. A portable sprayer, mister or fogger system according to claim 17, wherein the portable sprayer, mister or fogger system has an open back end having a blower guard arranged therein for protecting a user from getting their fingers or clothes caught in blades of the blower.

19. A portable sprayer, mister or fogger system according to claim 17, wherein the tubular member is made of a lightweight plastic so as to provide a portable, economic and easy to use system.

20. A portable sprayer, mister or fogger system according to claim 17, wherein the tubular member has one or more inner circumferential members for frictionally engaging and securing the blower therein when the living hinge is closed.
